(19) United States
(12) Patent Application Publication
(10) Pub. No.: US 2026/0251494 A1
(43) Pub. Date: Aug. 27, 2026

(54) SENSING SYSTEM, SENSING DEVICE, AND SENSING METHOD

(71) Applicant: NEC Corporation, Minato-ku, Tokyo (JP)

(72) Inventors: Tadayuki IWANO, Tokyo (JP); Koyo MORI, Tokyo (JP); Yukihide YODA, Tokyo (JP)

(73) Assignee: NEC Corporation, Minato-ku, Tokyo (JP)

(21) Appl. No.: 18/855,798

(22) PCT Filed: Apr. 25, 2022
(86) PCT No.: PCT/JP2022/018682

§ 371 Date: Oct. 10, 2024

(51) Int. Cl. G01H 9/00; G01D 5/353

(52) U.S. Cl. CPC G01H 9/004; G01D 5/35358

(57) ABSTRACT

A sensing system according to the present disclosure includes: a plurality of optical fibers (10); a communication unit (21) which at least one optical fiber (10) among the plurality of optical fibers (10) is connected to, the communication unit configured to transmit pulsed light to the at least one connected optical fiber (10) and receive an optical signal from the at least one optical fiber (10); and a determination unit (22) configured to determine whether or not a predetermined vibration has been generated in the at least one optical fiber (10) based on a vibration pattern indicating the predetermined vibration included in the optical signal received from the at least one optical fiber (10).

### TECHNICAL FIELD

The present disclosure relates to a sensing system, a sensing device, and a sensing method.

### BACKGROUND ART

In an office or the like, a connection device such as a patch panel is disposed between apparatuses such as a server and a computer in order to connect these apparatuses with an optical fiber.

Also, in a case where a removal work of apparatus is performed in an office or the like, another removal work of an optical fiber used for connection with the apparatus is also performed.

On the side of apparatus to be removed, since the optical fiber connected to the apparatus is to be removed, it is possible to easily specify the optical fiber to be removed.

However, in a situation where there is a long distance between the apparatus to be removed and the connection device, it is not possible to correctly determine which optical fiber is to be removed on the side of the connection device. Therefore, there is a possibility that an optical fiber in operation is incorrectly removed on the side of the connection device. As a result, incorrect disconnection of communication in operation also occurs.

Examples of related techniques for solving problems as described above include techniques described in Patent Literature 1 and Patent Literature 2.

In the technique described in Patent Literature 1, one optical fiber in an optical cable to be identified among a large number of optical cables is connected to an optical unit, and two optical signals having a phase difference and a time difference are sent to the one optical fiber. Then, the optical unit detects a phase difference or the like between two optical signals reflected by external scattering generated by a long-distance worker tapping a certain optical fiber, converts the detected optical signals into sound, and transmits sound through a first communication apparatus to the second communication apparatus of a long-distance worker. The long-distance worker identifies that the optical cable selected by the long-distance worker is correct when sounds being heard respectively through the first communication apparatus and the second communication apparatus are the same.

In the technique described in Patent Literature 2, an observer performs optical pulse testing on a plurality of optical fiber core wires in advance to obtain tested waveforms. A worker selects one of the plurality of optical fiber core wires, applies a bending loss as a disturbance to the selected optical fiber core wire, and notifies the observer that bending has been applied to the optical fiber core wire. In response to this, the observer performs optical pulse testing again in a state where the optical fiber is bent, thereby obtaining a waveform and comparing the waveform with tested waveforms. For the optical fiber core wire which is subjected to bending loss, reflection from a far end disappears or is attenuated, and a reflection peak disappears from the waveform. This is used to determine whether the optical fiber core wire is in/out of use.

### CITATION LIST

### Patent Literature

Patent Literature 1: Published Japanese Translation of PCT International Publication for Patent Application, No. 2010-522896

Patent Literature 2: Japanese Unexamined Patent Application Publication No. 2008-309958

### SUMMARY OF INVENTION

### Technical Problem

However, in the technique described in Patent Literature 1, it is necessary to transmit two optical signals having a phase difference and a time difference to the optical fiber, and it is necessary to detect a phase difference between the two optical signals reflected by external scattering and convert the detected optical signal into sound.

Also, in the technique described in Patent Literature 2, it is necessary to perform optical pulse testing on a plurality of optical fiber core wires in advance and recognize the location and number of reflection peaks.

Therefore, it is desired to suppress incorrect removal of the optical fiber by a simpler method.

Thus, in view of the above-described problems, an object of the present disclosure is to provide a sensing system, a sensing device, and a sensing method capable of suppressing incorrect removal of an optical fiber by a simpler method.

### Solution to Problem

A sensing system according to an aspect includes:
a plurality of optical fibers;
a communication unit which at least one optical fiber among the plurality of optical fibers is connected to, the communication unit configured to transmit pulsed light to the at least one connected optical fiber and receive an optical signal from the at least one optical fiber; and
a determination unit configured to determine whether or not a predetermined vibration has been generated in the at least one optical fiber based on a vibration pattern indicating the predetermined vibration included in an optical signal received from the at least one optical fiber.

A sensing device according to an aspect includes:
a communication unit which at least one optical fiber among a plurality of optical fibers is connected to, the communication unit configured to transmit pulsed light to the at least one connected optical fiber and receive an optical signal from the at least one optical fiber; and
a determination unit configured to determine whether or not a predetermined vibration has been generated in the at least one optical fiber based on a vibration pattern indicating the predetermined vibration included in an optical signal received from the at least one optical fiber.

A sensing method according to an aspect is a sensing method by a sensing device, wherein at least one optical fiber among a plurality of optical fibers is connected to the sensing device, the sensing method including:
a communication step of transmitting pulsed light to the at least one connected optical fiber and receiving an optical signal from the at least one optical fiber; and
a determination step of determining whether or not a predetermined vibration has been generated in the at least one optical fiber based on a vibration pattern indicating the predetermined vibration included in an optical signal received from the at least one optical fiber.

### Advantageous Effects of Invention

According to the above-described aspects, the effect of providing a sensing system, a sensing device, and a sensing method capable of suppressing incorrect removal of an optical fiber by a simpler method is obtained.

### BRIEF DESCRIPTION OF DRAWINGS

FIG. 1 is a diagram for illustrating an example of configuration of a sensing system according to a first example embodiment.

FIG. 2 is a view for illustrating an example of a vibration pattern of vibration artificially generated in an optical fiber.

FIG. 3 is a diagram for describing an example of operations in a case where a user applies pressure to a plurality of optical fibers one-by-one in order on the side of the patch panel in a sensing device according to the first example embodiment.

FIG. 4 is a diagram for describing an example of operations in a case where a user applies pressure to a plurality of optical fibers two-by-two in order on the side of the patch panel in the sensing device according to the first example embodiment.

FIG. 5 is a flowchart for illustrating an example of a flow of schematic operations of the sensing device according to the first example embodiment.

FIG. 6 is a diagram for illustrating an example of configuration of a sensing system according to a second example embodiment.

FIG. 7 is a diagram for illustrating an example of configuration of a sensing system according to a third example embodiment.

FIG. 8 is a diagram for illustrating an example of a GUI screen displayed on a display apparatus by a notification unit according to the third example embodiment.

FIG. 9 is a flowchart for illustrating an example of a flow of schematic operations of a sensing device according to the third example embodiment.

FIG. 10 is a diagram for illustrating an example of configuration of a sensing system according to other example embodiments.

FIG. 11 is a block diagram for illustrating an example of hardware configuration of a computer that implements a sensing device according to example embodiments.

### EXAMPLE EMBODIMENT

Hereinafter, example embodiments of the present disclosure are described with reference to the drawings. Further, the following description and drawings are skipped and simplified as appropriate for clarity of description. Also, in each of the drawings described below, the same elements are denoted by the same reference numerals, and repeated description is skipped as necessary.

### First Example Embodiment

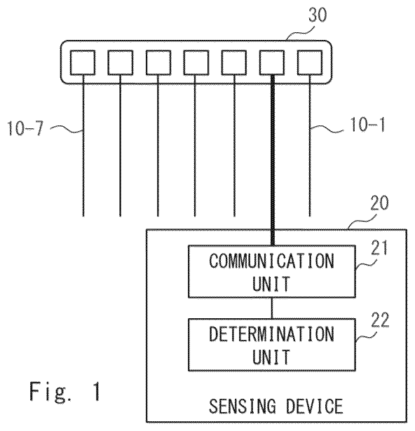

First, an example of configuration of a sensing system according to a first example embodiment will be described with reference to FIG. 1.

As illustrated in FIG. 1, the sensing system according to the first example embodiment includes a plurality of optical fibers 10-1 to 10-7 and a sensing device 20. Hereinafter, in a case where it is not necessary to specify which of the optical fibers 10-1 to 10-7 is being referred to, it will be simply referred to as an “optical fiber 10”, appropriately. Further, the number of the optical fibers 10 is seven in FIG. 1, but this is an example and the number of the optical fibers 10 may be two or more.

One end of the plurality of optical fibers 10 is connected to each port of a patch panel 30. The patch panel 30 is an example of a connection device. For example, in the form of an optical fiber cable configured by coating the optical fiber 10, the optical fiber 10 may be connected to the sensing device 20 and the patch panel 30.

Here, in the first example embodiment, it is assumed that the optical fiber 10 connected to the apparatus to be removed among the plurality of optical fibers 10 is to be removed. Also, it is assumed that because there is a long distance between apparatus to be removed and the patch panel 30, it is not possible to determine which optical fiber 10 among the plurality of optical fibers 10 is to be removed when viewed from the side of the patch panel 30.

In the first example embodiment, it is possible to determine which optical fiber 10 to be removed on the side of the patch panel 30 under the above-described situation.

For that reason, in the first example embodiment, the other end of one optical fiber 10 to be removed is connected to the sensing device 20 (specifically, a communication unit 21 described later). However, this is an example, and two or more optical fibers 10 to be removed may be connected to the sensing device 20 as described in a second example embodiment described later. That is, the number of optical fibers 10 to be removed that will be connected to the sensing device 20 may be at least one.

The sensing device 20 includes a communication unit 21 and a determination unit 22. However, the determination unit 22 may be provided in a separate apparatus different from the sensing device 20 or may be provided on a cloud. The sensing device 20 is implemented by, for example, a Distributed Vibration Sensing (DVS) apparatus, a Distributed Acoustic Sensing (DAS) apparatus, or the like.

As described above, the communication unit 21 is connected to the one optical fiber 10 to be removed. The communication unit 21 transmits pulsed light to the connected optical fiber 10. Then, as the pulsed light is transmitted through the optical fiber 10, backscattered light is generated. The communication unit 21 receives backscattered light from the connected optical fiber 10 as an optical signal.

In the first example embodiment, the user applies pressure to the plurality of optical fibers 10 by a method such as tapping with a rod in order on the side of the patch panel 30. By this pressure, artificial vibration is generated in the optical fiber 10.

When artificial vibration is generated in the optical fiber 10 by pressure, characteristics (for example, wavelength) of an optical signal transmitted through the optical fiber 10 change. Therefore, the optical fiber 10 may detect artificial vibration generated by pressure, and the optical signal transmitted through the optical fiber 10 includes a unique vibration pattern in which intensity of vibration, a vibration position, and the like are different depending on the artificial vibration.

So, the determination unit 22 determines whether or not artificial vibration (predetermined vibration) has occurred in the connected optical fiber 10, based on a vibration pattern indicating artificial vibration due to pressure included in the optical signal received by the communication unit 21.

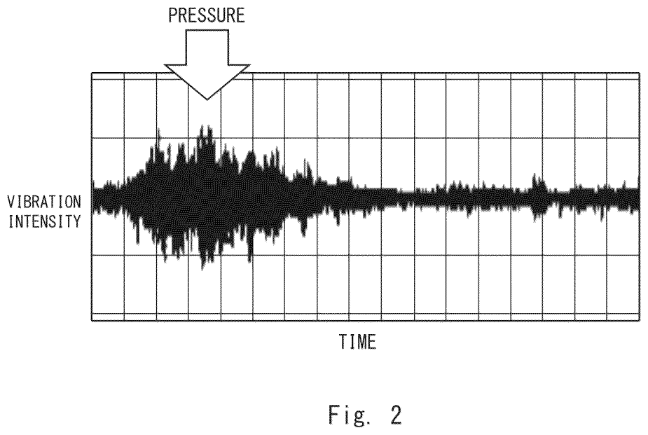

Here, an example of a vibration pattern of vibration artificially generated in the optical fiber 10 will be described with reference to FIG. 2. As described above, when vibration is generated in the optical fiber 10, the characteristics of the optical signal change. Therefore, the determination unit 22 may obtain vibration data as illustrated in FIG. 2 by analyzing the optical signals received by the communication unit 21 from the optical fiber 10 connected to the communication unit 21. FIG. 2 illustrates vibration data of vibration generated in the optical fiber 10, where the horizontal axis represents time and the vertical axis represents vibration intensity.

As illustrated in FIG. 2, in a case where vibration is artificially generated by pressure on the optical fiber 10, a vibration pattern in which the vibration intensity greatly fluctuates depending on artificial vibration appears in vibration data. Therefore, if the vibration pattern as illustrated in FIG. 2 appears, the determination unit 22 may determine that artificial vibration has been generated in the connected optical fiber 10.

In a case where the determination unit 22 determines that artificial vibration due to pressure has been generated in the connected optical fiber 10, the user on the side of patch panel 30 may determine that the optical fiber 10 which is exerting pressure at that time is to be removed.

Here, operations of the sensing device 20 will be described more specifically.

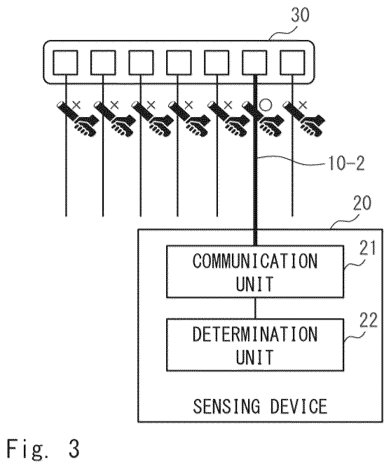

First, an example of operations of the sensing device 20 in a case where the user applies pressure to the plurality of optical fibers 10 one-by-one in order on the side of the patch panel 30 will be described with reference to FIG. 3. Further, the optical fiber 10 to be removed is the optical fiber 10-2 in FIG. 3.

As illustrated in FIG. 3, an optical fiber 10-2 to be removed is connected to the communication unit 21. The communication unit 21 transmits pulsed light to the optical fiber 10-2. Also, the communication unit 21 receives from the optical fiber 10-2 as an optical signal, backscattered light generated as the pulsed light is transmitted through the optical fiber 10-2.

While the communication unit 21 performs the operations described above, the user on the side of patch panel 30 applies pressure to the plurality of optical fibers 10 one-by-one in order.

Then, every time pressure is applied, the determination unit 22 determines whether or not artificial vibration due to pressure has been generated in the connected optical fiber 10-2. Specifically, this determination is made based on a vibration pattern indicating artificial vibration due to pressure included in the optical signal received by the communication unit 21.

As a result, when the user on the side of patch panel 30 applies pressure to the optical fiber 10-2, the determination unit 22 determines that artificial vibration due to pressure has been generated in the connected optical fiber 10-2. Therefore, the user on the side of patch panel 30 may determine that the optical fiber 10-2 which is exerting pressure at that time is to be removed.

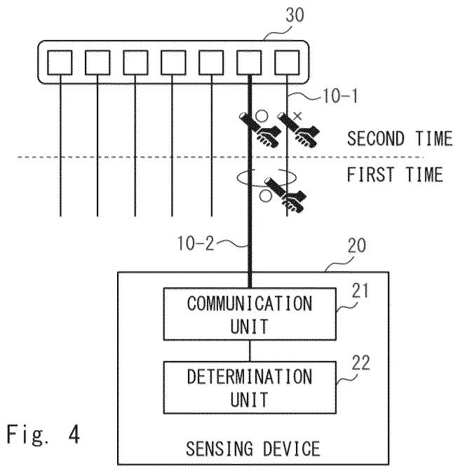

Next, an example of operations of the sensing device 20 in a case where the user applies pressure to the plurality of optical fibers 10 two-by-two in order on the side of patch panel 30 will be described with reference to FIG. 4. Further, the optical fiber 10 to be removed is also the optical fiber 10-2 in FIG. 4.

As illustrated in FIG. 4, the communication unit 21, similarly to FIG. 3, is connected to the optical fiber 10-2 to be removed, transmits pulsed light to the optical fiber 10-2, and receives an optical signal from the optical fiber 10-2.

While the communication unit 21 performs the operations described above, the user on the side of patch panel 30 applies pressure to the plurality of optical fibers 10 two-by-two in order.

Then, every time pressure is applied, the determination unit 22 determines whether or not artificial vibration due to pressure has been generated in the connected optical fiber 10-2.

As a result, when the user on the side of patch panel 30 applies pressure to the two optical fibers 10-1 and 10-2, the determination unit 22 determines that artificial vibration due to pressure has been generated in the connected optical fiber 10-2. Therefore, the user on the side of patch panel 30 may determine that any of the two optical fibers 10-1 and 10-2 which is exerting pressure at that time is to be removed, but may not specify the optical fiber 10 to be removed.

So, the user on the side of patch panel 30 performs the second pressure only on the two optical fibers 10-1 and 10-2 as the pressure target. At this time, the user on the side of patch panel 30 applies pressure to the two optical fibers 10-1 and 10-2 one-by-one in order.

As a result, when the user on the side of patch panel 30 applies pressure to the optical fiber 10-2, the determination unit 22 determines that artificial vibration due to pressure has been generated in the connected optical fiber 10-2. Therefore, the user on the side of patch panel 30 may determine that the optical fiber 10-2 which is exerting pressure at that time is to be removed.

Further, in the example of FIG. 3, it is assumed that pressure is applied to all of the plurality of optical fibers 10 and it is determined whether artificial vibration due to pressure has been generated in the connected optical fibers 10-2, but the present disclosure is not limited thereto. For example, in a case where it is determined that artificial vibration due to pressure has been generated in the connected optical fiber 10-2, the determination operation may be terminated even if there is an unpressed optical fiber 10 at that time. The same applies to the example of FIG. 4. For example, in a case where it is determined that artificial vibration due to pressure has been generated in the optical fiber 10-2 in the second pressure, the determination operation may be terminated even if the optical fiber 10-1 is unpressed at that time.

Also, in the examples of FIGS. 3 and 4, the user on the side of patch panel 30 applies the pressure to one or two optical fibers 10, but the number of optical fibers 10 which is exerting pressure at the same time is not limited to one or two, and may be three or more. That is, the number of optical fibers 10 which are exerting pressure at the same time may be a predetermined number. In a case where pressure has been applied to three or more optical fibers 10, it is sufficient to gradually narrow down the optical fibers 10 to be removed as in the example of FIG. 4.

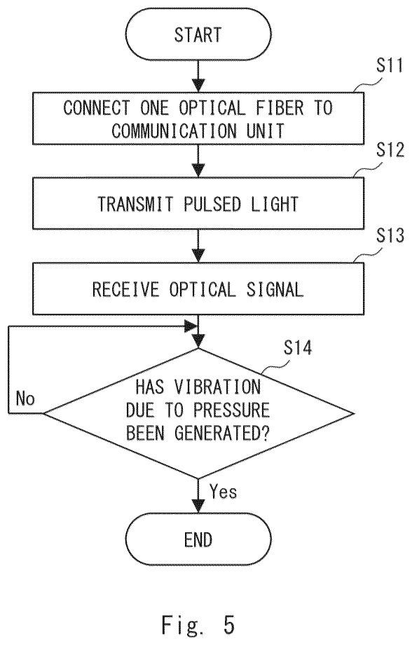

Next, an example of a flow of schematic operations of the sensing device 20 according to the first example embodiment will be described with reference to FIG. 5. Further, in FIG. 5, in a case where it is determined that artificial vibration due to pressure has been generated in the connected optical fiber 10, the determination operation is terminated at that time. Also, in the determination operation, it is assumed that the user on the side of patch panel 30 applies pressure to the plurality of optical fibers 10 one-by-one in order as illustrated in FIG. 3.

As illustrated in FIG. 5, the one optical fiber 10 to be removed is connected to the communication unit 21 (step S11). The communication unit 21 transmits pulsed light to the connected optical fiber 10 (step S12) and receives backscattered light for the pulsed light from the optical fiber 10 as an optical signal (step S13).

While the communication unit 21 performs the operations described above, the user on the side of patch panel 30 applies pressure to the plurality of optical fibers 10 one-by-one in order.

Every time the pressure is applied, the determination unit 22 determines whether or not the artificial vibration due to pressure has been generated in the connected optical fiber 10, based on a vibration pattern indicating the artificial vibration due to the pressure included in the optical signal received by the communication unit 21 (step S14).

The operation in step S14 is repeatedly performed until the determination unit 22 determines that artificial vibration due to pressure has been generated in the connected optical fiber 10, and then operations in FIG. 5 are terminated when it is determined that the vibration has been generated (Yes in step S14).

Further, in a case where there is a plurality of optical fibers 10 to be removed, the operations of FIG. 5 may be performed one-by-one on the plurality of optical fibers 10 to be removed.

As described above, according to the first example embodiment, the communication unit 21 is connected to the one optical fiber 10 to be removed among the plurality of optical fibers 10, transmits pulsed light to the connected optical fiber 10, and receives backscattered light for the pulsed light from the connected optical fiber 10 as an optical signal. The determination unit 22 determines whether or not artificial vibration has been generated in the connected optical fiber 10, based on a vibration pattern indicating artificial vibration due to pressure included in the optical signal received by the communication unit 21.

Therefore, in a case where the determination unit 22 determines that artificial vibration due to pressure has been generated in the connected optical fiber 10, the user on the side of patch panel 30 may correctly determine that the optical fiber 10 which is exerting pressure at that time is to be removed.

At this time, as in the technique described in Patent Literature 1, it is unnecessary to transmit two optical signals having a phase difference and a time difference to the optical fiber 10, and it is unnecessary to convert an optical signal received from the optical fiber 10 into sound.

Also, as in the technique described in Patent Literature 2, it is unnecessary to perform optical pulse testing on a plurality of optical fibers 10 in advance and recognize the location and number of reflection peaks.

Therefore, according to the first example embodiment, it is possible to suppress incorrect removal of the optical fiber 10 and incorrect disconnection of communication during operation by a simpler method.

Also, since the user on the side of patch panel 30 may correctly determine the optical fiber 10 to be removed, it is possible to quickly remove the optical fiber 10.

### Second Example Embodiment

In the first example embodiment described above, only one optical fiber 10 to be removed may be connected to the sensing device 20.

On the other hand, in the second example embodiment, two or more optical fibers 10 to be removed may be connected to the sensing device 20.

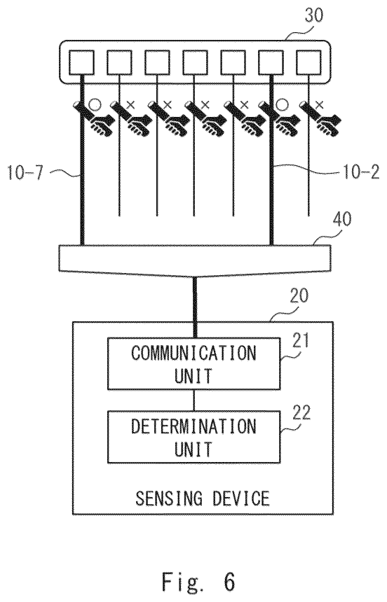

First, an example of configuration of a sensing system according to the second example embodiment will be described with reference to FIG. 6.

As illustrated in FIG. 6, the sensing system according to the second example embodiment is different from the configuration of FIG. 1 of the first example embodiment described above, in that a coupler 40 is added.

The coupler 40 is disposed between the sensing device 20 and the patch panel 30.

Two or more optical fibers 10 among the plurality of optical fibers 10 may be connected to the communication unit 21 of the sensing device 20 via the coupler 40.

Therefore, in the second example embodiment, two or more optical fibers 10 to be removed may be connected to the communication unit 21 via the coupler 40. In the example of FIG. 6, two optical fibers 10-2 and 10-7 are connected to the communication unit 21.

Further, basic operations of the sensing device 20 according to the second example embodiment are similar to those of the sensing device 20 according to the first example embodiment described above.

That is, in the example of FIG. 6, the communication unit 21 transmits pulsed light to the optical fiber 10-2 and receives an optical signal from the optical fiber 10-2, and transmits pulsed light to the optical fiber 10-7 and receives an optical signal from the optical fiber 10-7. The determination unit 22 determines whether or not artificial vibration has been generated in each of the optical fibers 10-2 and 10-7, based on a vibration pattern indicating artificial vibration due to pressure included in the optical signal received from each of the optical fibers 10-2 and 10-7 by the communication unit 21.

As a result, for example, in a case where the determination unit 22 determines that artificial vibration due to pressure has been generated in the optical fiber 10-2, the user on the side of patch panel 30 may determine that the optical fiber 10-2 which is exerting pressure at that time is to be removed. Also, in a case where the determination unit 22 determines that artificial vibration due to pressure has been generated in the optical fiber 10-7, the user on the side of patch panel 30 may determine that the optical fiber 10-7 which is exerting pressure at that time is to be removed.

Therefore, a detailed description of operations of the sensing device 20 according to the second example embodiment will be skipped.

As described above, according to the second example embodiment, the communication unit 21 is connected through a coupler 40 to the two or more optical fibers 10 to be removed, transmits the pulsed light to each of the two or more optical fibers 10, and receives backscattered light for the pulsed light from each of the connected two or more optical fibers 10 as an optical signal. The determination unit 22 determines whether or not artificial vibration has been generated in each of the two or more connected optical fibers 10, based on a vibration pattern indicating artificial vibration due to pressure included in the optical signal received from each of the two or more optical fibers 10 by the communication unit 21.

Therefore, even in a case where there are two or more optical fibers 10 to be removed, it is possible to determine whether or not artificial vibration has been generated in each of the two or more optical fibers 10 by collectively connecting the two or more optical fibers 10 to the communication unit 21. As a result, as compared with the first example embodiment described above, in a case where there are two or more optical fibers 10 to be removed, it is possible to skip the labor of connecting the optical fibers 10 to the communication unit 21 one-by-one in order.

The other effects are similar to the effects according to the first example embodiment described above.

### Third Example Embodiment

In the first example embodiment described above, the user has manually performed determining the optical fiber 10 to be removed on the side of patch panel 30 based on determination results of the determination unit 22.

On the other hand, in a third example embodiment, the optical fiber 10 to be removed on the side of patch panel 30 is determined on the side of the sensing device 20 (determination unit 22).

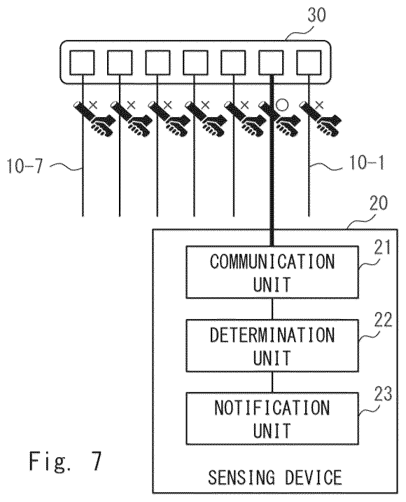

First, an example of configuration of a sensing system according to a third example embodiment will be described with reference to FIG. 7.

As illustrated in FIG. 7, the sensing system according to the third example embodiment is different from the configuration of FIG. 1 of the first example embodiment described above, in that a notification unit 23 is added to the sensing device 20 and a function of the determination unit 22 is extended.

In a case where it is determined that artificial vibration due to pressure has been generated in a specific optical fiber 10 among the optical fibers 10 to be removed, connected to the communication unit 21, the determination unit 22 determines that the specific optical fiber 10 is the same as the optical fiber 10 which is exerting pressure on the side of patch panel 30.

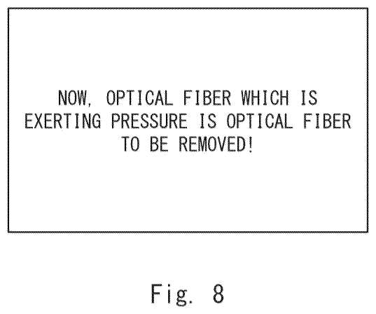

In a case where the determination unit 22 determines that the specific optical fiber 10 is the same as the optical fiber 10 which is exerting pressure on the side of patch panel 30, the notification unit 23 notifies a predetermined notification destination of the fact. For example, the notification unit 23 displays a Graphical User Interface (GUI) screen indicating that the specific optical fiber 10 is the same as the optical fiber 10 which is exerting pressure on the side of patch panel 30, on a display apparatus such as a display or a monitor of the predetermined notification destination. The display apparatus of the predetermined notification destination is, for example, a display apparatus on the side of patch panel 30. FIG. 8 illustrates an example of a GUI screen.

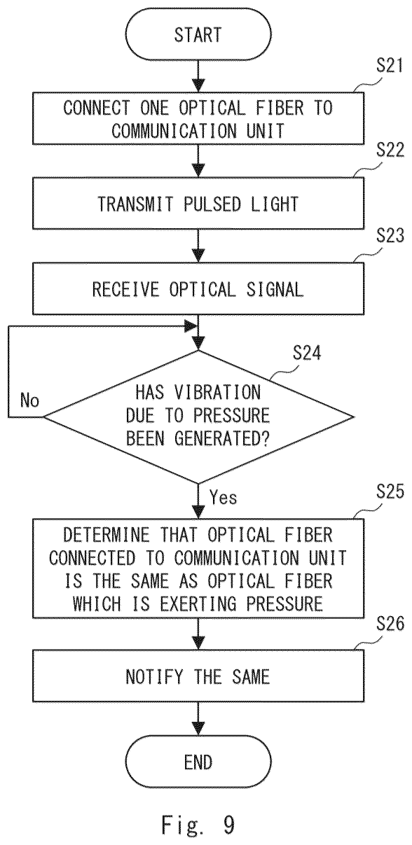

Next, an example of a flow of schematic operations of the sensing device 20 according to the third example embodiment will be described with reference to FIG. 9.

As illustrated in FIG. 9, first, the processing of steps S21 to S24 that is similar to the processing of steps S11 to S14 in FIG. 5 according to the first example embodiment described above is performed.

In step S24, in a case where it is determined that artificial vibration due to pressure has been generated in a specific optical fiber 10 among the optical fibers 10 to be removed, connected to the communication unit 21 (Yes in step S24), the determination unit 22 further determines that the specific optical fiber 10 is the same as the optical fiber 10 which is exerting pressure on the side of patch panel 30 (step S25).

Thereafter, the notification unit 23 notifies a predetermined notification destination that the specific optical fiber 10 is the same as the optical fiber 10 which is exerting pressure on the side of patch panel 30 (step S26). This notification may be performed, for example, by displaying the GUI screen as illustrated in FIG. 8 on the display apparatus of the predetermined notification destination.

As described above, according to the third example embodiment, in a case where it is determined that artificial vibration due to pressure has been generated in a specific optical fiber 10 among the optical fibers 10 to be removed, connected to the communication unit 21, the determination unit 22 further determines that the specific optical fiber 10 is the same as the optical fiber 10 which is exerting pressure on the side of patch panel 30, and the notification unit 23 notifies the predetermined notification destination of the fact. As a result, it is possible to notify, for example, the user on the side of patch panel 30 that the optical fiber 10 to be removed is the same as the optical fiber 10 which is exerting pressure on the side of patch panel 30.

The other effects are similar to the effects according to the first example embodiment described above.

### Other Example Embodiments

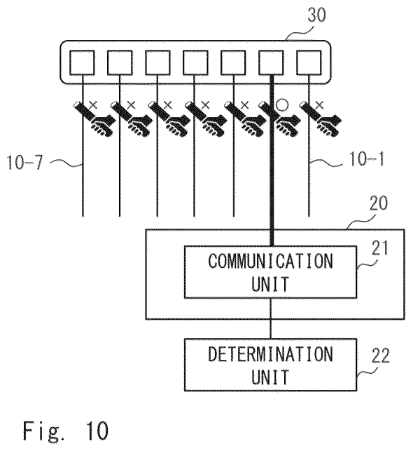

In the first example embodiment described above, the communication unit 21 and the determination unit 22 are provided inside the sensing device 20, but the present disclosure is not limited thereto. The determination unit 22 may be provided in a separate apparatus different from the sensing device 20 or may be provided on a cloud. FIG. 10 illustrates an example of configuration of a sensing system provided with the determination unit 22 outside the sensing device 20.

Further, in the sensing system illustrated in FIG. 10, the notification unit 23 may be provided inside or outside the sensing device 20 as in the third example embodiment described above.

### Hardware Configuration of Sensing Device According to Example Embodiments

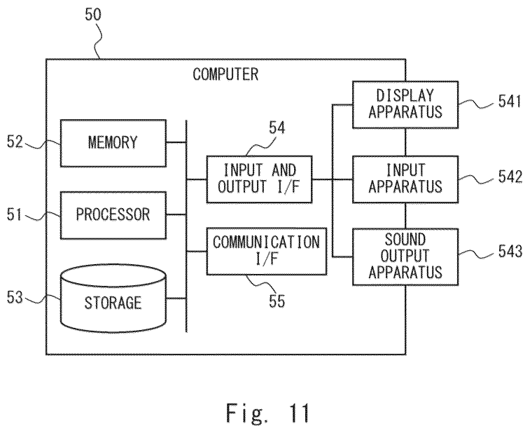

Next, an example of hardware configuration of a computer 50 that implements the sensing device 20 according to each example embodiment described above will be described with reference to FIG. 11.

As illustrated in FIG. 11, the computer 50 includes a processor 51, a memory 52, a storage 53, an input and output interface (input and output I/F) 54, a communication interface (communication I/F) 55, and the like. The processor 51, the memory 52, the storage 53, the input and output interface 54, and the communication interface 55 are connected by a data transmission path for mutually transmitting and receiving data.

The processor 51 is an arithmetic processing apparatus such as a central processing unit (CPU) or a graphics processing unit (GPU). The memory 52 is, for example, a memory such as a Random Access Memory (RAM) or a Read Only Memory (ROM). The storage 53 is, for example, a storage device such as a Hard Disk Drive (HDD), a Solid State Drive (SSD), or a memory card. Also, the storage 53 may be a memory such as a RAM or a ROM.

A program is stored in the storage 53. This program includes a group of instructions (or software code) for causing the computer 50 to execute one or more functions of the sensing device 20 described above when being read by the computer. The components in the sensing device 20 described above may be implemented by the processor 51 reading and executing a program stored in the storage 53. Also, the storage function in the sensing device 20 described above may be implemented by the memory 52 or the storage 53.

Also, the above-described program may be stored in a non-transitory computer readable medium or a tangible storage medium. As an example and not by way of limitation, the computer readable medium or the tangible storage medium includes a RAM, a ROM, a flash memory, an SSD or other memory technology, a compact disc (CD)-ROM, a digital versatile disc (DVD), a Blu-ray (registered trademark) disk or other optical disk storages, a magnetic cassette, a magnetic tape, a magnetic disk storage, or other magnetic storage devices. The program may be transmitted on a transitory computer readable medium or a communication medium. As an example and not by way of limitation, transitory computer readable or communication media include electrical, optical, acoustic, or other forms of propagated signals.

The input and output interface 54 is connected to a display apparatus 541, an input apparatus 542, a sound output apparatus 543, and the like. The display apparatus 541 is an apparatus that displays a screen corresponding to depiction data processed by the processor 51, such as a Liquid Crystal Display (LCD), a Cathode Ray Tube (CRT) display, and a monitor. The input apparatus 542 is an apparatus that receives an operation input of an operator, and is, for example, a keyboard, a mouse, a touch sensor, or the like. The display apparatus 541 and the input apparatus 542 may be integrated and implemented as a touch panel.

The sound output apparatus 543 is an apparatus that acoustically outputs a sound corresponding to audio data processed by the processor 51, such as a speaker.

The communication interface 55 transmits and receives data to and from an external apparatus. For example, the communication interface 55 communicates with an external apparatus via a wired communication path or a wireless communication path.

The present disclosure has been described above with reference to the example embodiments, but the present disclosure is not limited to the example embodiments described above. Various modifications that could be understood by those skilled in the art may be made to the configuration and details of the present disclosure within the scope of the present disclosure. For example, some or all of the above-described example embodiments may be used in combination with one another.

Also, some or all of the above-described example embodiments may be described in Supplementary Notes below, but are not limited thereto.

### Supplementary Note 1

A sensing system including:
a plurality of optical fibers;
a communication unit which at least one optical fiber among the plurality of optical fibers is connected to, the communication unit configured to transmit pulsed light to the at least one connected optical fiber and receive an optical signal from the at least one optical fiber; and
a determination unit configured to determine whether or not a predetermined vibration has been generated in the at least one optical fiber based on a vibration pattern indicating the predetermined vibration included in an optical signal received from the at least one optical fiber.

### Supplementary Note 2

The sensing system according to Supplementary Note 1, wherein
one end of the plurality of optical fibers is connected to a connection device,
the other end of the at least one optical fiber among the plurality of optical fibers is connected to the communication unit, and the predetermined vibration is an artificial vibration artificially generated by a predetermined number in order on the side of the connection device for the plurality of optical fibers.

### Supplementary Note 3

The sensing system according to Supplementary Note 2, wherein in a case where it is determined that the predetermined vibration has been generated in a specific optical fiber among the at least one optical fiber, the determination unit determines that the specific optical fiber is the same as the optical fiber that has generated the artificial vibration on the side of the connection device.

### Supplementary Note 4

The sensing system according to Supplementary Note 3, further including a notification unit configured to notify a predetermined notification destination of the fact in a case where it is determined by the determination unit that the specific optical fiber is the same as the optical fiber that has generated the artificial vibration on the side of the connection device.

### Supplementary Note 5

The sensing system according to Supplementary Note 4, wherein the notification unit displays a screen indicating that it is determined by the determination unit that the specific optical fiber is the same as the optical fiber that has generated the artificial vibration on the side of the connection device, on a display apparatus of the predetermined notification destination.

### Supplementary Note 6

A sensing device including:
a communication unit which at least one optical fiber among a plurality of optical fibers is connected to, the communication unit configured to transmit pulsed light to the at least one connected optical fiber and receive an optical signal from the at least one optical fiber; and
a determination unit configured to determine whether or not a predetermined vibration has been generated in the at least one optical fiber based on a vibration pattern indicating the predetermined vibration included in an optical signal received from the at least one optical fiber.

### Supplementary Note 7

The sensing device according to Supplementary Note 6, wherein
one end of the plurality of optical fibers is connected to a connection device,
the other end of the at least one optical fiber among the plurality of optical fibers is connected to the communication unit, and
the predetermined vibration is an artificial vibration artificially generated by a predetermined number in order on the side of the connection device for the plurality of optical fibers.

### Supplementary Note 8

The sensing device according to Supplementary Note 7, wherein in a case where it is determined that the predetermined vibration has been generated in a specific optical fiber among the at least one optical fiber, the determination unit determines that the specific optical fiber is the same as the optical fiber that has generated the artificial vibration on the side of the connection device.

### Supplementary Note 9

The sensing device according to Supplementary Note 8, further including a notification unit configured to notify a predetermined notification destination of the fact in a case where it is determined by the determination unit that the specific optical fiber is the same as the optical fiber that has generated the artificial vibration on the side of the connection device.

### Supplementary Note 10

The sensing device according to Supplementary Note 9, wherein the notification unit displays a screen indicating that it is determined by the determination unit that the specific optical fiber is the same as the optical fiber that has generated the artificial vibration on the side of the connection device, on a display apparatus of the predetermined notification destination.

### Supplementary Note 11

A sensing method by a sensing device, wherein at least one optical fiber among a plurality of optical fibers is connected to the sensing device, the sensing method including:
a communication step of transmitting pulsed light to the at least one connected optical fiber and receiving an optical signal from the at least one optical fiber; and
a determination step of determining whether or not a predetermined vibration has been generated in the at least one optical fiber based on a vibration pattern indicating the predetermined vibration included in an optical signal received from the at least one optical fiber.

### Supplementary Note 12

The sensing method according to Supplementary Note 11, wherein
one end of the plurality of optical fibers is connected to a connection device,
the other end of the at least one optical fiber among the plurality of optical fibers is connected to the sensing device, and
the predetermined vibration is an artificial vibration artificially generated by a predetermined number in order on the side of the connection device for the plurality of optical fibers.

### Supplementary Note 13

The sensing method according to Supplementary Note 12, wherein in a case where it is determined in the determination step that the predetermined vibration has been generated in a specific optical fiber among the at least one optical fiber, it is determined that the specific optical fiber is the same as the optical fiber that has generated the artificial vibration on the side of the connection device.

### Supplementary Note 14

The sensing method according to Supplementary Note 13, further including a notification step of notifying a predetermined notification destination of the fact in a case where it is determined in the determination step that the specific optical fiber is the same as the optical fiber that has generated the artificial vibration on the side of the connection device.

### Supplementary Note 15

The sensing method according to Supplementary Note 14, wherein in the notification step, a screen indicating that it is determined in the determination step that the specific optical fiber is the same as the optical fiber that has generated the artificial vibration on the side of the connection device is displayed on a display apparatus of the predetermined notification destination.

### REFERENCE SIGNS LIST

10-1 to 10-7 OPTICAL FIBER
20 SENSING DEVICE
21 COMMUNICATION UNIT
22 DETERMINATION UNIT
23 NOTIFICATION UNIT
30 PATCH PANEL
40 COUPLER
50 COMPUTER
51 PROCESSOR
52 MEMORY
53 STORAGE
54 INPUT AND OUTPUT INTERFACE
541 DISPLAY APPARATUS
542 INPUT APPARATUS
543 SOUND OUTPUT APPARATUS
55 COMMUNICATION INTERFACE

What is claimed is:

1. A sensing system comprising:
a plurality of optical fibers;
a transceiver which at least one optical fiber among the plurality of optical fibers is connected to, the transceiver configured to transmit pulsed light to the at least one connected optical fiber and receive an optical signal from the at least one optical fiber; and
at least one memory storing instructions, and
at least one processor configured to execute the instructions to determine whether or not a predetermined vibration has been generated in the at least one optical fiber based on a vibration pattern indicating the predetermined vibration included in an optical signal received from the at least one optical fiber.

2. The sensing system according to claim 1, wherein
one end of the plurality of optical fibers is connected to a connection device,
the other end of the at least one optical fiber among the plurality of optical fibers is connected to the transceiver, and
the predetermined vibration is an artificial vibration artificially generated by a predetermined number in order on the side of the connection device for the plurality of optical fibers.

3. The sensing system according to claim 2, wherein in a case where it is determined that the predetermined vibration has been generated in a specific optical fiber among the at least one optical fiber, the at least one processor is further configured to execute the instructions to determine that the specific optical fiber is the same as the optical fiber that has generated the artificial vibration on the side of the connection device.

4. The sensing system according to claim 3, wherein the at least one processor is further configured to execute the instructions to notify a predetermined notification destination of the fact in a case where it is determined that the specific optical fiber is the same as the optical fiber that has generated the artificial vibration on the side of the connection device.

5. The sensing system according to claim 4, wherein the at least one processor is further configured to execute the instructions to display a screen indicating that it is determined that the specific optical fiber is the same as the optical fiber that has generated the artificial vibration on the side of the connection device, on a display apparatus of the predetermined notification destination.

6. A sensing device comprising:
a transceiver which at least one optical fiber among a plurality of optical fibers is connected to, the transceiver configured to transmit pulsed light to the at least one connected optical fiber and receive an optical signal from the at least one optical fiber; and
at least one memory storing instructions, and
at least one processor configured to execute the instructions to unit configured to determine whether or not a predetermined vibration has been generated in the at least one optical fiber based on a vibration pattern indicating the predetermined vibration included in an optical signal received from the at least one optical fiber.

7. The sensing device according to claim 6, wherein
one end of the plurality of optical fibers is connected to a connection device,
the other end of the at least one optical fiber among the plurality of optical fibers is connected to the transceiver, and
the predetermined vibration is an artificial vibration artificially generated by a predetermined number in order on the side of the connection device for the plurality of optical fibers.

8. The sensing device according to claim 7, wherein in a case where it is determined that the predetermined vibration has been generated in a specific optical fiber among the at least one optical fiber, the at least one processor is further configured to execute the instructions to determine that the specific optical fiber is the same as the optical fiber that has generated the artificial vibration on the side of the connection device.

9. The sensing device according to claim 8, wherein the at least one processor is further configured to execute the instructions to notify a predetermined notification destination of the fact in a case where it is determined that the specific optical fiber is the same as the optical fiber that has generated the artificial vibration on the side of the connection device.

10. The sensing device according to claim 9, wherein the at least one processor is further configured to execute the instructions to display a screen indicating that it is determined that the specific optical fiber is the same as the optical fiber that has generated the artificial vibration on the side of the connection device, on a display apparatus of the predetermined notification destination.

11. A sensing method by a sensing device, wherein at least one optical fiber among a plurality of optical fibers is connected to the sensing device, the sensing method comprising:
a communication step of transmitting pulsed light to the at least one connected optical fiber and receiving an optical signal from the at least one optical fiber; and
a determination step of determining whether or not a predetermined vibration has been generated in the at least one optical fiber based on a vibration pattern indicating the predetermined vibration included in an optical signal received from the at least one optical fiber.

12. The sensing method according to claim 11, wherein
one end of the plurality of optical fibers is connected to a connection device,
the other end of the at least one optical fiber among the plurality of optical fibers is connected to the sensing device, and
the predetermined vibration is an artificial vibration artificially generated by a predetermined number in order on the side of the connection device for the plurality of optical fibers.

13. The sensing method according to claim 12, wherein in a case where it is determined in the determination step that the predetermined vibration has been generated in a specific optical fiber among the at least one optical fiber, it is determined that the specific optical fiber is the same as the optical fiber that has generated the artificial vibration on the side of the connection device.

14. The sensing method according to claim 13, further comprising a notification step of notifying a predetermined notification destination of the fact in a case where it is determined in the determination step that the specific optical fiber is the same as the optical fiber that has generated the artificial vibration on the side of the connection device.

15. The sensing method according to claim 14, wherein in the notification step, a screen indicating that it is determined in the determination step that the specific optical fiber is the same as the optical fiber that has generated the artificial vibration on the side of the connection device is displayed on a display apparatus of the predetermined notification destination.
